(19) United States
(12) Patent Application Publication
(10) Pub. No.: US 2011/0035250 A1
(43) Pub. Date: Feb. 10, 2011

(54) Ad-Hoc Engagement of Client and Service Provider

(75) Inventor: Rob Finucan, Manotick (CA)

Correspondence Address: PERLEY-ROBERTSON, HILL & MCDOUGALL LLP, 1400-340 Albert Street, OTTAWA, ON, K1R 0A5, CA

(73) Assignee: DUNGOLDEN GROUP INC., Ottawa (CA)

(21) Appl. No.: 12/535,735

(22) Filed: Aug. 5, 2009

(51) Int. Cl. G06Q 10/00; G06Q 30/00; H04W 4/00

(52) U.S. Cl. 705/9; 455/466; 705/26.1

(57) ABSTRACT

Amongst the many interactions people have are those which are unplanned such as door-to-door salespersons, charity canvassers, etc. In such situations the individual receiving the unplanned visit is disadvantaged in gaining information to make an informed decision in respect of the services offered to them. According to the invention a social networking application exploiting ad-hoc communications establishes a request for a visit with an individual allowing them to accept/decline as well as opportunity through the social networking application to retrieve information regarding the standing of the business, the individual, products as well as customer feedback. This additional information forming part of their decision making process. Businesses not part of the social networking application therefore derive reduced success in cold calling. Alternative embodiments allow for improved efficiencies in delivery/collection as well as pull based “wish” requesting from the individual rather than push advertising.

### FIELD OF THE INVENTION

This invention relates to providing enhanced services to customers and more specifically to exploiting localized ad-hoc networks and social networking type applications to provide said services.

### BACKGROUND OF THE INVENTION

The Technology, Media and Telecommunications (TMT) business has grown in the past 10 years with the widespread deployment of wireless devices, personal computers, Internet, and broadband networks to represent a value chain of over $3 trillion worldwide, including content providers, advertisers, telecommunications companies and electronics suppliers (White Paper Wireless Social Networking from iSuppli, July 2008). In the next decade wireless networking products, applications, components, and advertising will generate more than $2.5 trillion in revenue by 2020, according to iSuppli (Press Release, Jun. 4, 2008 http://www.isuppli.com/NewsDetail.aspx?ID=12930).

During the next decade it is anticipated that mobile devices, such as cellular telephones, smart phones, personal digital assistants (PDA), will become the primary channel for consumers to engage in communications with friends, family, businesses etc from conventional telephone conversations, short messaging services (SMS or text as commonly known) through to viewing content from or accessing the Internet (World Wide Web). Already wireless lines represent approximately 60% of supported lines for AT&T (77 million wireless “lines” versus 55 million fixed access lines in 2008, see AT&T 2008 Annual Report http://www.att.com/Common/about_us/annual_report/pdfs/2008ATT_FullReport.pdf). This market penetration occurring essentially in little more than a decade versus nearly a century for the fixed access telephone.

Further most applications such consumers have exploited such as social networking, weblogs (also commonly known as blogs), etc as well as emerging applications such as Twitter™ (a micro-blogging social networking application) will also have moved largely into the wireless realm providing the degree and type of ubiquitous connection that consumers demand. At the same time it is anticipated that this evolution with be accompanied by the creation of a new generation of applications that will greatly expand the appeal and utility of social networking, as well as leveraging the advancements in processing speed, memory storage, etc allowing rapid and accurate searching of content 24/7/365 from nearly anywhere and exploiting multiple networking topologies to provide the connectivity consumers demand. Such connectivity being supported with a network evolution from so-called third generation (3G) infra-structure with macrocells (i.e. high power base stations) and microcells (i.e. low power base stations) to fourth generation (4G) networks supporting picocells, femtocells and the formation of dynamic ad-hoc networks to support the density of users and bandwidth of service provisioning.

It is anticipated that these new applications will have to be intuitive to consumers and enabled by innovative technologies, which will be introduced in the timeframe from 2009 to 2015 and accordingly spur the adoption of dynamic ad-hoc networking as a feature of consumers everyday lives. Today there are essentially three levels of users, these being immediate family and close friends, extended friends, and shared interest groups. Today users interact sporadically, but intensely, with extended friends through games, avatars, and general updates and information. Users with common interests communicate in ways that extend into business. The popularity of social networking in business, for trading, online collaboration, and virtual meetings, is also likely to spur advancement of mobile devices equipped for content viewing and sharing.

Accordingly, as users move to such wireless devices as their primary means of communicating, accessing content, and using applications in the next decade, the technological innovations will also have to appear within the semiconductor and display industries globally. Increasingly displays will emerge as the most valuable portion of the mobile-device value chain, with makers of portable wireless devices stressing differentiation via superior display technology rather than features which have been important to date including battery lifetime, weight, size, full keyword, etc.

Accordingly display technologies, like touch screens, flexible displays, and motion sensors, will become increasingly important, while demand rises for highly integrated processors that combine numerous high-performance, multi-threaded special purpose cores as consumers expect performance in their wireless devices comparable to the dedicated special purpose processors they exploit today in gaming consoles, wireless devices, and personal computers. Additionally companies that supply the core silicon, microprocessors, graphics accelerators, memory, etc for these wireless networking devices will increasingly need to balance software and firmware engineers alongside hardware engineers and semiconductor processing specialists.

These trends run against those experienced to date within the computer applications arena where the focus has to date been on providing applications and building subscriber numbers and databases for applications where subscribers pay nothing or very little and the enterprises building these hope to make a return from medium to long term strategies of offering enhanced services with fees or introducing advertising for example to generate revenue.

So if we consider a typical hypothetical user of today then we find that they have both a personal computer (PC) and a smart phone, and that whilst their smart phone has a browser and they should be able to access most online sources that they can access from their PC, particularly those with wireless application protocol (WAP). However they do not use their smart phone as a computer, they use their PC for work or for anything that is a task requiring more than a couple of minutes. On the other hand they use their smart phone for short online tasks when on the move, limiting access time due to the subscriber plan they have with their service provider, such as Verizon™, AT&T™, T-Mobile™, BT™ etc. They will extend their access time if they are able to find a free wireless hotspot.

Typically these users today will be within the age range 18-35 although significantly the age distribution is shifting younger as school children are increasingly provided with wireless devices by concerned parents or those submitting to peer pressure. Such user activities are based around writing emails, accessing social network sites such as Facebook™, Hi5™, LinkedIn™, Flickr™, Classmates™, Last™, MySpace™, Twitter™, Windows Live Spaces™, etc, where they read and comment on friends blogs, and upload pictures, as well as Google Talk™, Windows Live Messenger™ and Skype™ for chatting. Users within the 18-35 demographic will also access other applications such as YouTube™, Yahoo Personals™, etc.

Despite, and in many instances because of, this massive number of active users of social networking applications it can be extremely difficult for a user to quickly retrieve information regarding a service, individual, business or other organization. Consider an individual with a blocked drain in Ottawa, Ontario. They access Canada411 a web based directory including businesses and search against the key word “drain”, this returns 250 “hits” for businesses within the Ottawa region. Which is best, how have others found their services, do they charge exorbitant amounts after quoting low rates for a job, are they fast, are they professional, etc. Our user is familiar with three names having seen their vans around town many times, these being Roto Rooter™, Mr Rooter™ and Drain All™. Searching on the Internet for each of these using Google™ returns 897,000; 533,000; and 13,800,000 “hits” respectively for these firms. Restricting the web based search to the business name and adding the keyword Ottawa reduces these “hits” to 4,820; 4,280; and 617,000 respectively.

Hence, even restricting the search to what the user believes are reputable businesses that he has seen working around Ottawa in many locations and over a reasonable period of time does not greatly enhance the user's ability to identify how other consumers have found these businesses and rate them. Amongst these thousands of “hits” are many consumer comments which are buried within “blogs” such as Facebook™ or “micro-blogs” such as Twitter™. Additionally the user is unaware of consumer satisfaction reviews and surveys provided by consumers in response to questionnaires from independent survey enterprises either on behalf of the service provider directly or extracted in relation to another service provider. For example, a consumer purchasing items at Home Depot™ may be provided with a questionnaire that includes questions regarding their satisfaction of shopping at Home Depot™ and how they rate this for example against Lowes™. Perhaps the user after using a web browser such as Google™ proceeds to an organization such as Better Business Bureau (www.bbb.org) to acquire additional information in order to make an informed decision. However, all of this extends the amount of time that the user takes in order to make this decision. In many situations the user does not have such time available, for instance a clogged drain, a burst water pipe, a major electrical failure within their residence, and disaster recovery from fire, storms etc. Given enough time and effort, a prudent buyer (the user) can rationalize their choices using information sources at their disposal but in many cases such as those identified above the immediacy of the situation opens itself to placing the buyer in a situation of overpaying, receiving bad service, etc.

It would therefore be beneficial to provide the consumer with an application that provided a coordinated hosting for such information relating to a business or businesses allowing the consumer to make an informed decision as to whether to purchase from the service provider. It would be further beneficial for the application to exploit social networking applications in addition to centralized survey type resources to provide this business review.

Against this background a variety of routine day-to-day activities that consumers are engaged in stay today rooted in tradition and exploit the same methods as our parents or even grandparents were exposed to. So a door-to-door salesperson will today walk along a street in a neighborhood and sequentially knock on each door in the hope of firstly finding a resident at home who answers the door and secondly who is interested in discussing the topic relating to the service or goods provided by the door-to-door salesperson, which may for example be locking in their utility to a provider for a quoted lower rate, offering gardening services, selling vacuum cleaners, or a charity seeking donations.

Now for the consumer at home when the door-to-door salesperson there is now the problem of being able to decide whether to answer the door, and if they do so how can they verify the information provided to them. For example, has the business employing the door-to-door salesperson been reported many times to consumer bureaus for high pressure sales tactics, is the person actually employed by the business they purport to represent and are not for example gaining signatures under false pretences for identity theft and illegal activities, or have other consumers found that the follow through provision of services has fallen short of the promises made by the door-to-door salesperson representing the business. Issues such as these affect everyone when responding to the doorbell and finding it is a door-to-door salesperson. But these problems can be particularly exacerbated when the resident answering the door is for example elderly, or female, male, young, mentally or physically disabled for example and confronts a salesperson they find intimidating, seductive, or endearing for example. In these situations whilst different to the instances discussed supra in respect of clogged drains, electrical failures etc there is still an immediacy to the situation that does not allow the consumer at home sufficient time to make an informed decision as to how they should deal with the unknown person at the door. Additionally it is not only important that the consumer know that the business and the information that is being presented can be trusted but also verify the identity of the individual or the business they represent.

It would therefore be beneficial to provide an application that provided for a resident or consumer to be notified that a door-to-door salesperson was in their neighborhood and allowed them to retrieve information from a trusted information source. Such information including for example a rating for the business by other customers, identification information regarding the door-to-door salesperson to verify them, and other information summaries or detailed content derived from a variety of social networking applications relating to the business. In this manner the consumer may determine in advance, simultaneously, or shortly after an ad-hoc network is established whether to answer the door, and may in fact extend an invitation to the salesperson, advise the salesperson that they would meet at another more convenient time, decline to meet or contact a friend or family member to come and help them engage in the conversation with the salesperson. It would be further beneficial if the identification of the salespersons proximity to the consumer was made via the formation of an ad-hoc network allowing the application to operate even in areas of poor or no wireless coverage and under conditions of service outage etc. Establishing the ad-hoc network may exploit one or more wireless standards in use currently, as well as others that evolve with time. Such standards including for example IEEE 802.15.1 (Bluetooth™), IEEE 802.11 (Wireless LAN), IEEE 802.16 (WiMAX), Industrial, Scientific and Medical bands (ITU-R 5.138, 5.150, and 5.280), RF and cellular (GSM 850, 900, 1800, 1900), 3G networks and 4G networks.

It would be a further benefit if consumers wishing to engage a particular business or enterprise were able to proactively identify an interest in meeting a salesperson or other member of a business or offer a reverse offering to the business. An example in the latter case being providing used clothing to the Salvation Army. Accordingly the user may use the application to identify an interest or offer for example which is then communicated to a person associated with the business when they establish ad-hoc communication to the consumers device either by passing their residence, passing within vicinity of each other in their daily lives, or where the consumer passes a centralized hub supporting the application for multiple businesses. Such a centralized hub for example being within a retail establishment most people visit, e.g. a supermarket or shopping mall/centre, or another regular activity such as filling their vehicle with gas/petrol/diesel or depositing/withdrawing money from an automatic teller machine (ATM).

### SUMMARY OF THE INVENTION

It is an object of the present invention to obviate or mitigate at least one disadvantage of the prior art.

In accordance with an embodiment of the invention there is provided a method comprising:
(a) providing a send device associated with a provider comprising at least a first transmitter operating according to a first wireless standard;
(b) providing a receive device comprising at least a receiver operating according to the first standard and a display, the receive device associated with a user;
(c) receiving at the receive device a request message from the send device, the request message transmitted by other than a public switched telephone network and comprising data relating to at least one of a request for a meeting between the provider and the user and an identity of the provider;
(d) displaying on the receive device a predetermined portion of the request message; and
(e) determining in dependence upon at least the request data an action, the action relating to the request for the meeting between the provider and the user.

In accordance with another embodiment of the invention there is provided a method comprising:
(a) providing a send device of a plurality of send devices, each send device associated with a user comprising at least a first transmitter operating according to a first wireless standard;
(b) providing a receive device comprising at least a receiver operating according to the first standard and a memory, the receive device associated with a provider;
(c) receiving at the receive device a message from the send device of the plurality of send devices, the message transmitted by other than a public switched telephone network and comprising data relating to at least one of a request from the user and an identity relating to the user;
(d) storing within the memory of the receive device a predetermined portion of the message; and
(e) determining in dependence upon at least the data relating to the request a first action.

In accordance with another embodiment of the invention there is provided a method comprising:
(a) providing at least one wireless device of a plurality of wireless devices, each wireless device associated with a user and comprising at least a transmitter operating according to a wireless standard and a memory;
(b) storing within a predetermined portion of the plurality of wireless devices data, the data stored within each wireless device of the predetermined portion of the plurality of wireless devices relating to a request of the user associated with that wireless device of the plurality of wireless devices;
(c) transmitting from a base station operating according to the wireless standard a request; and
(d) transmitting from at least each wireless device of the predetermined portion of the plurality of wireless devices the data relating to the request of the user when the wireless device has received the request

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is schematic of a door-to-door salesperson's engagement with residents according to the prior art;

FIG. 2 is a schematic of a charity collecting from residents according to the prior art; and

FIG. 3 is an exemplary schematic of a door-to-door salesperson's engagement with residents according to an embodiment of the invention wherein the resident and salesperson interact via an ad-hoc network;

FIG. 4 is an exemplary flow diagram of an engagement between a salesperson and a resident according to an embodiment of the invention;

FIG. 5 is an exemplary flow diagram of an engagement between a salesperson and a resident according to an embodiment of the invention wherein the resident obtains information from the social networked application;

FIG. 6 is a schematic of a charity's engagement with residents according to an embodiment of the invention exploiting ad-hoc networking;

FIG. 7 is an exemplary flow diagram of an engagement between a service provider and resident with the resident updating the social networking application;

FIG. 8 is an schematic of a charity's engagement with residents according to an embodiment of the invention exploiting localized broadcast and ad-hoc networking;

FIG. 9 is an exemplary flow diagram for the addition of a new business to the social networking application to retrieve and store customer comments; and

FIG. 10 is a schematic of a resident notifying a service provider of an interest by forming an ad-hoc network with an item of infrastructure common to their daily routine.

### DETAILED DESCRIPTION

The present invention is directed to providing enhanced interactions between individuals, such as residents, customers, and consumers for example, with enterprises, such as businesses and charities, wherein these interactions occur typically outside of normal commercial or retail areas such as for example the street, their residence, etc.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

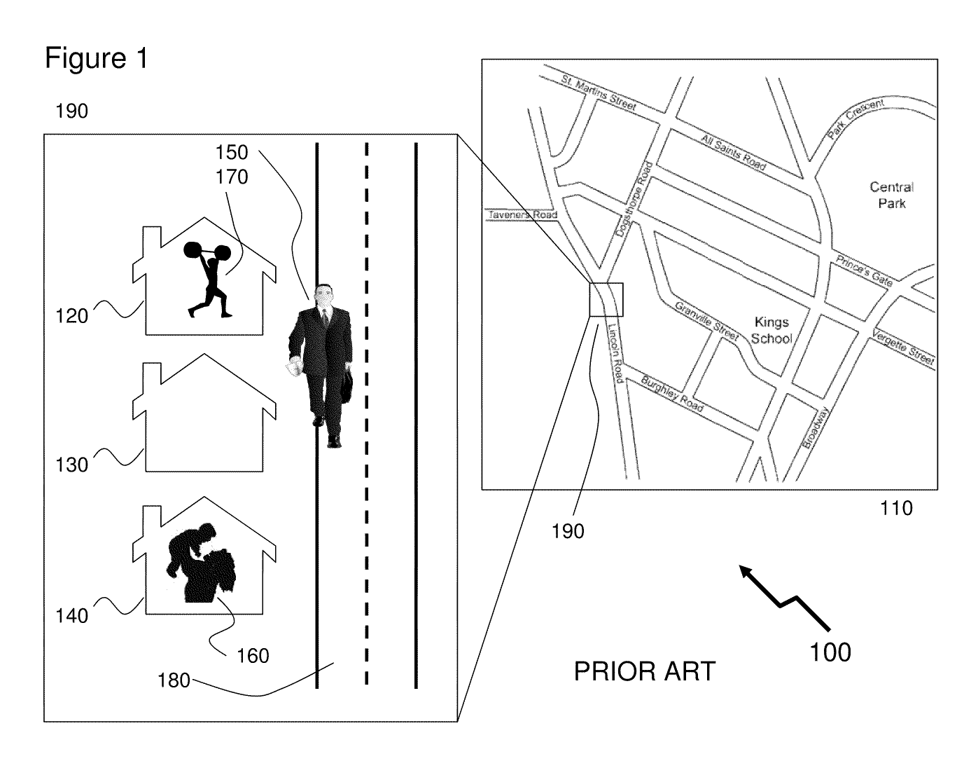

As shown in FIG. 1 there is a schematic 100 of a door-to-door salesperson's engagement with residents according to the prior art. As shown within schematic 100 there is a map 110 of a district of Peterborough, England with a region 190 which is part of Lincoln Road shown in expanded form. Within region 190 a salesperson 150 is walking along the road 150, in this case Lincoln Road but it could be any within the vicinity as the salesperson 150 canvasses the neighborhood. In this region 190 are first to third houses 120, 130, and 140 respectively at which the salesperson 150 sequentially visits and attempts to contact a resident within. At first house 120 the salesperson 150 engages with man 170 who is home and working out. At second house 130 the salesperson 150 obtains no response as noone is currently home. At third house 140 the salesperson 150 does not get a response despite the presence of the resident, Mom 160, as she is currently busy with her child.

At the first house 120 the salesperson 150 will engage man 170 in a conversation introducing himself as a salesperson for “Too Good” a business selling a variety of household cleaning products. Depending upon the discussion the salesperson 150 will typically either find out that man 170 is not interested, is interested but does not have the time right now, or is interested and executes an order with the salesperson 150. This order may optionally be made after the salesperson 150 has demonstrated a household cleaning product to man 170. Clearly time is wasted by the salesperson 150 in engaging second house 130 where noone was home when he called, and at third house 140 where Mom 160 was too busy at that particular point in time to meet him but in 5 minutes perhaps may have been free to do so. Similarly man 170 may have been busy at that point in time but would have been free to talk and more receptive in half an hour after he had finished his workout rather than being interrupted.

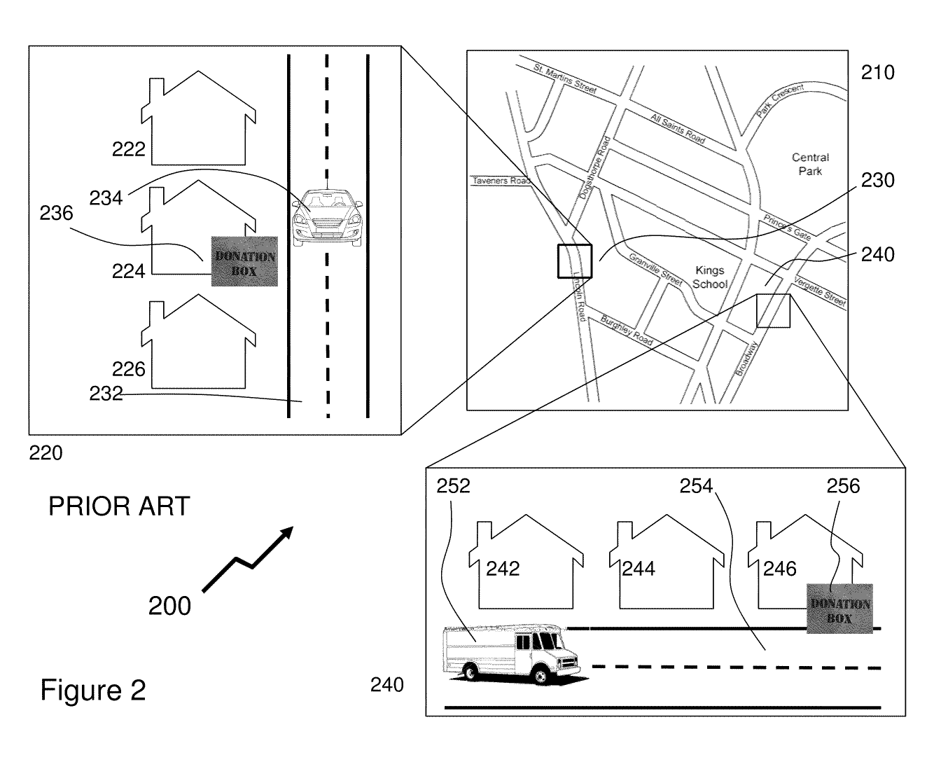

Referring to FIG. 2 is a schematic of a charity collecting from residents with a region 210 of Peterborough, England according to the prior art. Within region 210 are highlighted first and second street regions 220 and 240, being on Lincoln Road and Broadway respectively. Within first street region 220 a first collection vehicle 234 for a charity, for example “Alzheimer's Society”, is upon first street 232 and passing first to third houses 222 to 226 respectively. The resident at second house 224 has previously spoken to the “Alzheimer's Society” and advised them that they have a donation box 236 of second hand clothing to be collected upon a certain day. The “Alzheimer's Society” therefore dispatches the first collection vehicle 234 to a series of addresses including second house 224 to collect these donations.

Similarly within second street region 240 a second collection vehicle 252 representing another charity, for example “Scope”, is upon second street 254 and passing fourth to sixth houses 242 to 246 respectively. The resident at the sixth house 246 having similarly arranged the collection from “Scope” by calling the charity previously to advise them of the donation 256 at which point they were asked to leave it out on a predetermined day that the second collection vehicle 252 would be within the second street region 240.

Accordingly the only way that “Alzheimer's Society” and “Scope” know that the residents of second home 224 and sixth home 246 respectively have donation box 236 and donation 256 for collection. The residents of the other homes, being first home 222, third home 226, fourth home 242, and fifth home 244 do not know that the charity would be collecting from their neighborhood and accordingly despite having items that are or might have been available as a result do not have these available. As a result the charities lose out on donations or have to expend additional expense and resources returning to the same first street region 220 and second street region 240 to collect donations from these other houses.

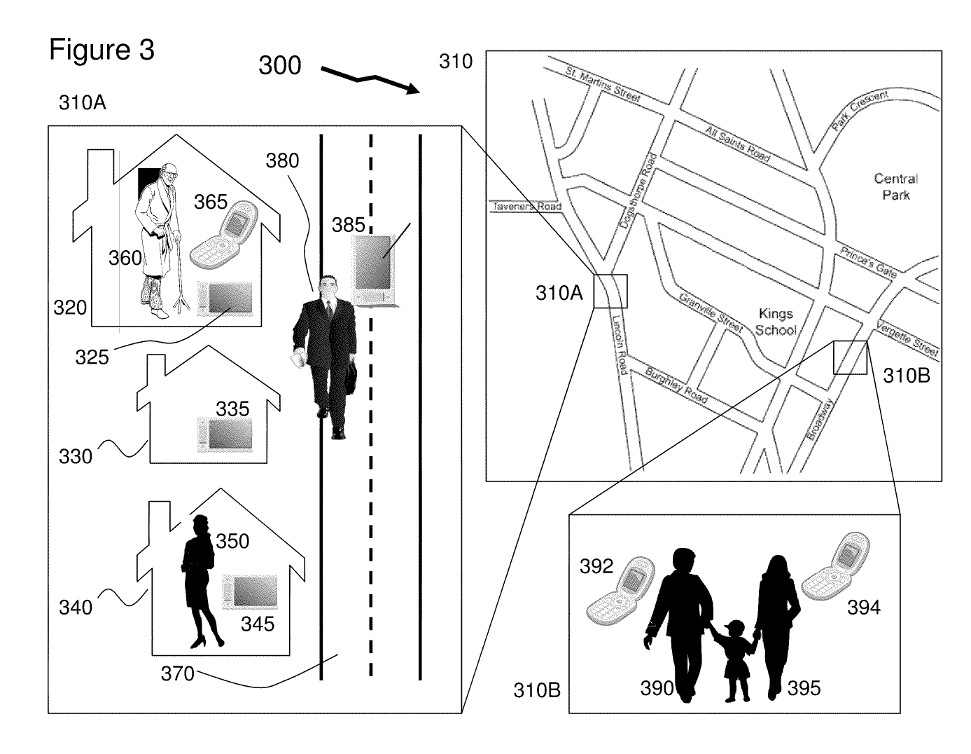

Now referring to FIG. 3 there is an exemplary schematic 300 of a door-to-door salesperson's 380 engagement with first and second residents 350 and 360 according to an embodiment of the invention wherein the first and second residents 350 and 360 and salesperson 380 initially interact via an ad-hoc network. As shown within exemplary schematic 300 there is shown the same region of Peterborough, England in map 310 wherein a street portion 310A is highlighted and depicted in expanded detail. This street portion 310A comprises street 370, Lincoln Road, and first through third houses 320 to 340. Walking along the street 370 is salesperson 380 who is carrying their wireless device 385. As salesperson 380 walks along the street 370 past the first house 320 their wireless device 385 forms part of an ad-hoc network with first node 325 associated with the first house 320 and it's resident 360 who is elderly. In forming the ad-hoc network between the first node 325 and wireless device 385 the resident 360 is advised of the salesperson 380 being local and wishing to meet the resident 360.

Resident 360 can thereby communicate with salesperson 380 and notify them as to whether they wish to meet with them. The communication from salesperson 380 when forming the ad-hoc network including for example the business, products, etc that the salesperson 380 is trying to sell. Resident 360 prior to committing or rejecting the option to meet salesperson 380, and thereby advising them via the ad-hoc network formed between the first node 325 and wireless device 385, asks the salesperson 380 to hold. The resident 360 then uses a second wireless device 365 to call their son 390 on their cell phone 392 in order to ask them to come meet with themselves and the salesperson 380 as they are hesitant or fear to meet alone as they feel they might be pressured into purchasing something they do not want. Failing to get a response from their son 390 they call their daughter-in-law 395 on their PDA 394. In the case that their daughter-in-law 395 answers and is able to come to the first house at that time the resident 360 can commit to a meeting with the salesperson 380. If daughter-in-law 395 cannot make a visit at that the time the resident 360 may reject a meeting with salesperson 380.

Accordingly, based upon the events at first house 320 then salesperson 380 walks along the street 370 wherein they then form an ad-hoc network with the second node 335 of second house 330. As no-one is home within second house 330 the salesperson 380 receives no response from the communication from their initial message generated by their wireless device 385 when it formed the ad-hoc network with the second node 335. As a result the salesperson 380 moves further down the street 370 until their wireless device 385 forms an ad-hoc network with the third node 345 of the third house 340. Currently the owner 350 is at home and responds to the notification on their third node 345 that the salesperson 380 would like to visit and discuss their business and product offerings. As the owner 350 has no interest in the product offerings they decline the invitation from the salesperson 380.

As a result salesperson 380 can establish quickly and conveniently whether there are owners/residents of the houses within a region they are targeting who wish to meet them. Accordingly the salesperson 380 can manage their time more advantageously in that they have now a limited number of qualified meetings rather than a large number of possible meetings. Additionally the owners/residents of these houses do not find themselves responding to calls from door-to-door salespeople, charities etc

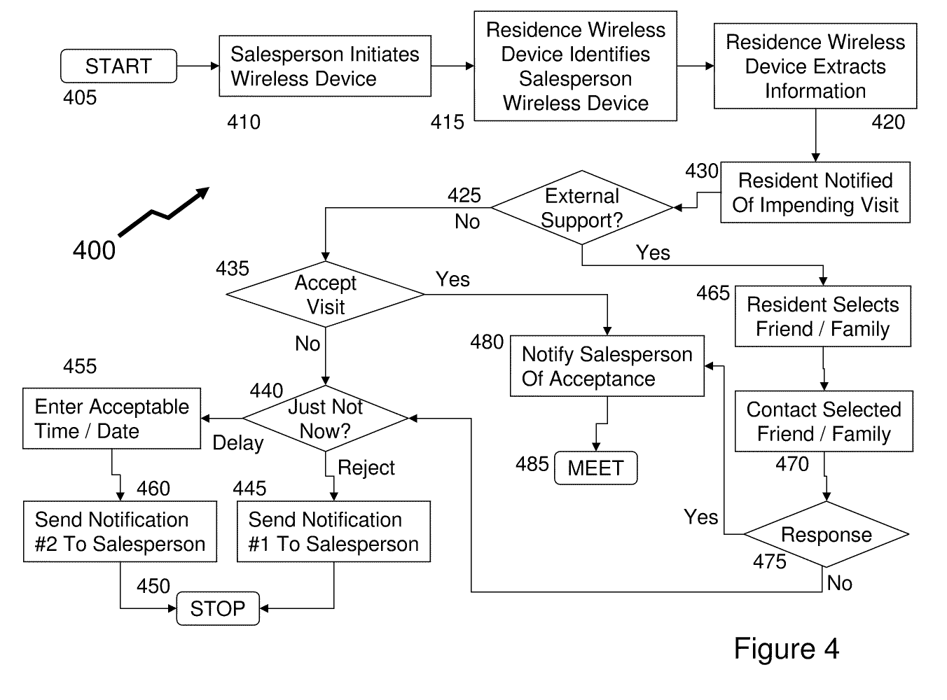

As such exemplary schematic 300 addresses issues such as reducing time wasted by the salesperson in engaging where no one was home when they called or where the resident was too busy at that particular point in time to meet him but in 5 minutes perhaps may have been free to do so. Similarly the resident may have been busy but still met the salesperson and made a commitment. In many instances the resident will make a commitment to the salesperson and there is a potential problem with buyer's remorse. “Did I overpay?” and “Was I under pressure?” being typical second doubts arising within a buyer's mind after such salesperson visits. Another is “Was this an attempt to “case the house” for valuable contents, security systems, occupants?” Although there are laws in place that allow consumers to “rethink” their positions, it is possible that if the transaction was small, it may not be worthwhile for them to try to get their money back or they may be too embarrassed to admit to anybody that they were duped. One of the benefits of the invention as is evident from the embodiment presented in FIG. 3 together with those following in FIGS. 4, 5, and 7 for example below is that the opportunity to become duped is greatly diminished and that there would not be a necessity to even go through the hassle of trying to get a refund. There are many examples of people spending hours and hours trying to track down organizations and trying to speak to somebody that would then cancel a contract, or provide refund.

It would be evident to one skilled in the art that the resident rather than contacting a family member, i.e. son 390 or daughter-in-law 395, with a second wireless device 365 may alternatively use the first node 325 they received the request from the salesperson upon if that first node 325 is a cellular telephone, telephone, PDA, etc. Alternatively the person contacted may not be a family member but could be for example a friend, a work colleague, an individual associated with the residence of the user, such as for example a caretaker within a managed residence, caregiver within a managed care facility, or an individual associated with their current location.

Referring to FIG. 4 is an exemplary flow 400 of an engagement between a salesperson and a resident according to an embodiment of the invention such as between salesperson 380 and resident 360 of first house 320 in FIG. 3 supra. The exemplary flow 400 begins at step 405 where a salesperson is ready to being canvassing a neighborhood for sales. The flow moves forward to step 410 where the salesperson initiates their wireless device which contains a social networking application configured to forming ad-hoc networks with local wireless devices and advising other devices within the ad-hoc networks of information determined by the owner of the wireless device initiating the ad-hoc networks, in this case the salesperson's wireless device. The process then moves forward with the salesperson's wireless device transmitting an initial contact signal which is received by local wireless devices, such as the first node 325 in the first house 320 of resident 360.

As such in step 415 the resident wireless device identifies the wireless device of the salesperson and in step 420 extracts the information predetermined by the salesperson, such as the identity of the salesperson, their business, and product offerings for example. The wireless device within the resident's house, for example first node 325 in FIG. 3 supra, notifies the resident in step 430 that the salesperson is within the neighborhood and would like to meet the resident in order to present their business and product offerings. The resident prior to responding to the initial contact determines in step 425 whether they require external support in this meeting. Examples of such scenarios being that the resident is elderly, infirm, disabled, or lacks confidence. If the resident determines in step 425 that they do not require support the exemplary flow 400 moves to step 435 wherein the resident decides whether to accept the visit.

If the resident determines to meet the salesperson at that point then the process moves forward to step 480 wherein the salesperson is notified of the acceptance of the request to meet wherein the flow moves forward to step 485 wherein the resident and salesperson meet and the flow stops. If the resident determines to not meet the salesperson then the process moves forward to step 440 and the resident now determines whether the decision not to meet is a complete rejection or whether it is merely that the timing is inconvenient. If the determination is a complete rejection then the process moves forward to step 445 and a first notification message is sent from the resident's wireless device to the salesperson's wireless device and then the flow moves to step 450 and stops. If the determination was that the timing was inconvenient then the process moves to step 455 wherein the resident is prompted to enter an acceptable time and date. This is then combined in step 460 with additional information to provide the second notification message to the salesperson, wherein the flow moves forward to step 450 and stops.

If in step 425 the resident had determined that they need external support then the flow would have moved to step 465 wherein the resident selects a friend or family member that they would like to contact and the flow moves forward to step 470 and the friend or family member is contacted by the resident to see if they are available. At step 470 the flow shifts according to whether the friend or family member is contacted and are available or not. If the friend or family member is available immediately the flow moves to step 480 and notifies the salesperson that the resident will be able to meet. If the friend or family member is not available then the flow moves to step 440 and executes according to notify the salesperson as to an acceptable time/date for a subsequent meeting or may proceed to reject the opportunity completely. This later scenario occurring for example as the friend/family member in discussing the potential salesperson's visit advises the resident that there is no point in meeting as they do not need the service(s) or product(s) on offer.

It would be apparent that the process of the resident providing an acceptable time and date may be an iterative process wherein the salesperson may provide an alternative time and date based upon their schedule. Alternatively another possibility is nothing happens after the information is delivered to the homeowner, and although exemplary flow 400 presents politeness in that a response is generated to a sales person on declining a meeting, another possible outcome is that nothing happens and that is also an end to the interaction. Optionally the process flow may be established by a user preference for example to always send a notice to a trusted individual or individuals, such as friends or family members. Within this embodiment and others presented below the wireless device could be anything from a simple card with a transmitter that sends an identity (uni-directional) to a fully sophisticated device such as a PDA or smart phone capable of two way communication depending on the application. Hence, the wireless device could be an RFID tag or Bluetooth enabled tag that is only capable of transmitting but not receiving. This would be important for organizations that would need to keep costs down but still be part of the system.

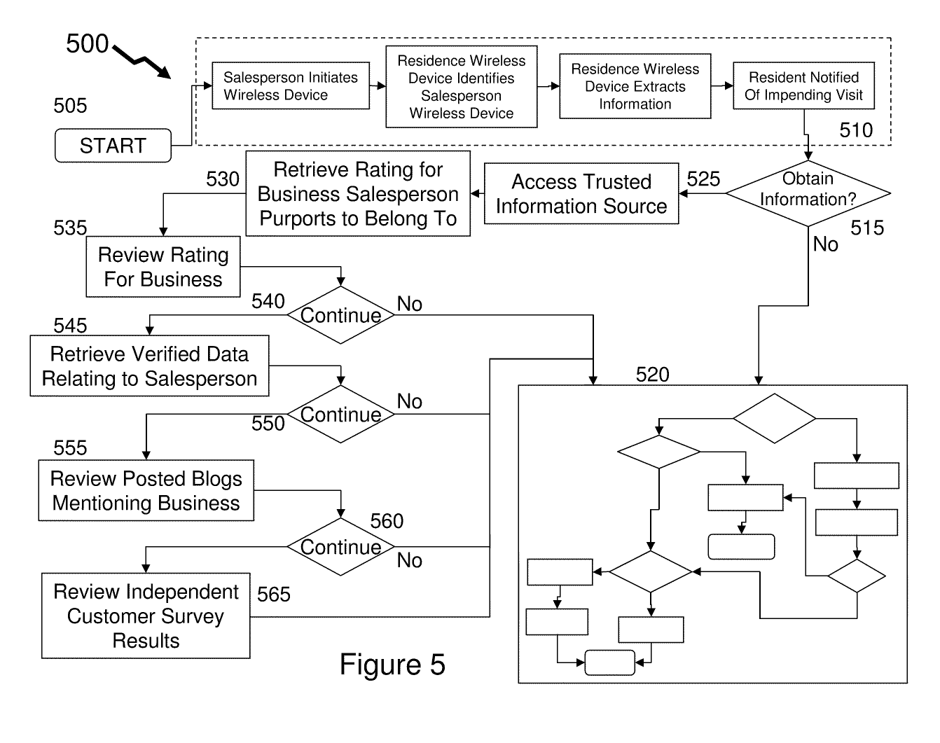

Now referring to FIG. 5 there is shown an exemplary process flow 500 of an engagement between a salesperson and a resident according to an embodiment of the invention wherein the resident obtains information from the social networked application. As such the process begins at step 505 and moves forward to first process block 510 wherein the salesperson initiates their wireless device and establishes an ad-hoc network with a resident and notifies them of a wish to visit and discuss a service(s)/product(s). The first process block 510 for example being equivalent to the process steps 410 through 420 of exemplary flow diagram 400 in FIG. 4 supra. Prior to determining whether the resident wishes to meet the salesperson they decide in step 515 whether they wish to retrieve information concerning the business the salesperson purports to represent. If resident decides not to obtain further information then the process moves forward to second process block 520 which is equivalent to steps 420 through 485 of FIG. 4 supra wherein the resident determines whether to meet the salesperson, determines whether to have a third party such as friend/family member present, determines a suitable time/date for the meeting and notifies the salesperson via the ad-hoc network. Accordingly the exemplary process flow 500 will terminate within second process block 520.

If the resident decides to obtain further information the process moves to step 525 wherein the resident's device, for example first node 325 associated with first house 320 and resident 360 of FIG. 3 supra, accesses a first external resource which is a trusted information source, such as for example the “Better Business Bureau” (www.bbb.org), and in step 530 retrieves a business rating associated with the business the salesperson purports to represent. In step 535 the resident reviews the information retrieved concerning the business and determines in step 540 whether they have sufficient information or wish to retrieve more. If they determine that they have sufficient information then the process moves forward to second process step 520 and terminates after the resident has advised the salesperson of their desire/lack of desire to meet.

If the resident determines in step 540 to retrieve additional information the process moves to step 545 wherein information relating to the salesman is retrieved from the trusted information source. This information may for example include customer reviews relating specifically to the salesperson, a photograph of the salesperson, and a profile of the salesperson generated by the business they represent. The process then moves to step 550 where the resident determines whether they have sufficient information or wish to retrieve more. If they determine that they have sufficient information then the process moves forward to second process step 520 and terminates after the resident has advised the salesperson of their desire/lack of desire to meet.

If the resident determines in step 550 to retrieve additional information the process moves to step 555 and the resident is able to review posted blogs that have been verified as relating to the business. These may for example be blogs from employees of the business, customers of the business, etc. The process then moves to step 560 where the resident determines whether they have sufficient information or wish to retrieve more. If they determine that they have sufficient information then the process moves forward to second process step 520 and terminates after the resident has advised the salesperson of their desire/lack of desire to meet.

If the resident determines in step 560 to retrieve additional information the process moves to step 565 and the resident is able to review independent customer survey results relating to the business. The process then moves to step 560 where the resident determines whether they have sufficient information or wish to retrieve more. If they determine that they have sufficient information then the process moves forward to second process step 520 and terminates after the resident has advised the salesperson of their desire/lack of desire to meet.

It would be evident that the device forming the ad-hoc network with the salesperson, for example first node 325 of FIG. 3, and their personal wireless device, for example second wireless device 365, may be the same device. Alternatively the sequence of options presented to the resident may be varied or optionally the resident selects from a list of these options so that they retrieve initially the information they consider most relevant. It would also be apparent that the options presented supra may be indexed according to other aspects such that for example the resident can retrieve customer reviews and surveys relating to vacuum cleaners rather than ovens, refrigerators, freezers, and ventilation equipment all manufactured and sold by the business the salesperson represents.

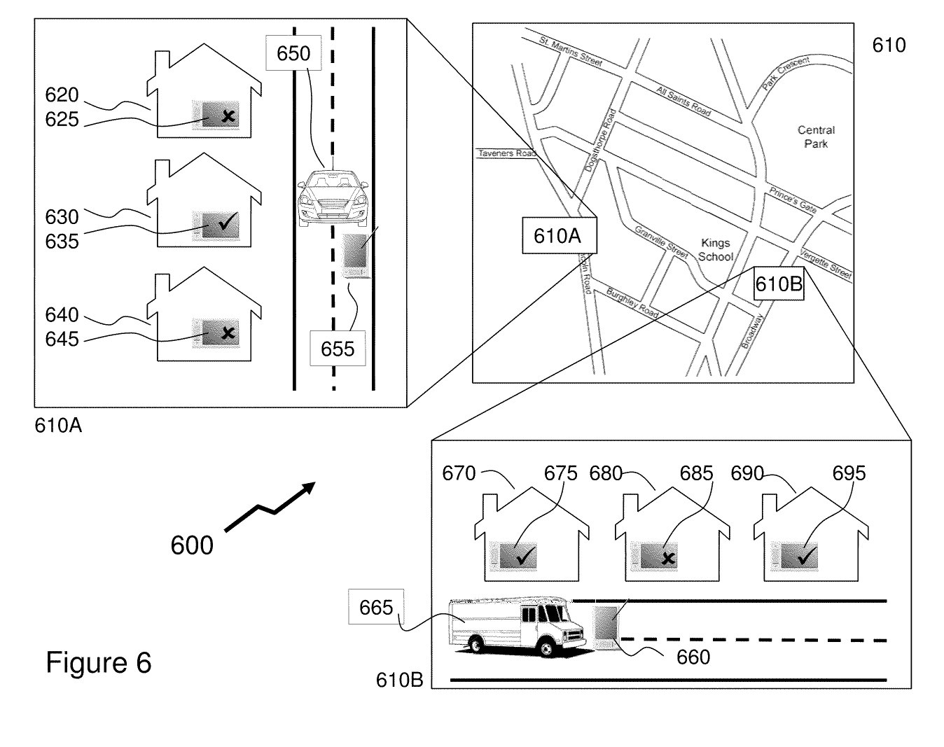

Referring now to FIG. 6 there is shown a schematic 600 of a charity's engagement with residents according to an embodiment of the invention exploiting ad-hoc networking. There is shown again a map 610 of a part of Peterborough, England with first and second street sections 610A and 610B respectively, being parts of Lincoln Road and Broadway respectively. Within first street section 610A there is a first charity vehicle 650 which has associated with it a first device 655 such that as the first charity vehicle 650 moves along Lincoln Road it forms ad-hoc networks with first to third nodes 625, 635, and 645 respectively of first to third homes 620, 630 and 640 respectively. As such the first device 655 receives a positive response from first node 625, a negative response from second node 635 and positive response from third node 645. In the instances of positive responses these indicate that the residents at these homes have items for collection by the charity. The first device 655 and the first to third nodes 625, 635, and 645 having accessible upon them a social networking application orientated to ad-hoc networking and providing information relating to services, products, availability, etc.

Within second street section 610B there is a second charity vehicle 660 which has associated with it a first device 665 such that as the second charity vehicle 660 moves along Lincoln Road it forms ad-hoc networks with first to third nodes 625, 635, and 645 respectively of fourth to sixth homes 670, 680 and 690 respectively. As such the second device 665 receives a positive response from sixth node 675, a negative response from fifth node 685 and positive response from sixth node 695. In the instances of positive responses these indicate that the residents at these homes have items for collection by the charity. The second device 655 and the fourth to sixth nodes 625, 635, and 645 having accessible upon them a social networking application orientated to ad-hoc networking and providing information relating to services, products, availability, etc.

It would be apparent that beneficially a charity or group of charities may advertise within the media that they will be within an area collecting and indicating what they wish to collect etc and that making the selection within the appropriate social networking application will allow them to collect from people without requiring them to call the charity of charities to arrange the collection. In this manner a wider population based should donate and do so in a manner that is simpler and more commensurate with their normal activities. Additionally from the client's perspective, they get the benefit of not having to take the clothing to a centralized location or drop off point, which helps with people who don't have their own method of transportation or those where it is simply inconvenient and hence previously they are just throwing the used clothing out with the trash.

Alternatively the social networking application may be exploited by other enterprises including for example refuse collection, utilities etc to sequence activities with residents based upon the information obtained from the ad-hoc networking communications. Further it would be evident that the ad-hoc social networking application may be exploited by residents to identify opportunities for a business to engage with them, thereby reversing the scenarios presented supra in respect of a salesperson proactively contacting residents. Hence, if for example within the social networking application could highlight areas of interest, for example making a retirement plan, buying a car, purchasing a vacuum cleaner then they can add this to a “desire” or “wish” list type aspect of the social networking application. Then if an individual or vehicle of a business associated with one of these “desires” or “wishes” may establish an ad-hoc network with the resident's wireless device and identify this “desire” or “wish” and communicate this to a central office of the business wherein that business can contact the resident. Optionally if the device the resident employs is a personal wireless device such as PDA or cellular telephone then this interaction may occur at any point they are traveling etc. In addition to larger items, or items of significant financial value, the social networking applicant works also with more mundane commodities such as “litre of milk”, “girl guide cookies”, and “newspapers” for example. Accordingly another potential embodiment is for businesses to address that aspect of society known as “we are getting to lazy to go out and get stuff for ourselves”. Accordingly businesses such as grocery stores, convenience stores, liquor stores etc may become more like couriers and take their products, at a higher margin due to convenience, to residents who identify such items as milk, bread, butter, candy, beer etc within their “wishes”. Potentially such an application is also better for the environment to have one vehicle delivering groceries etc., to the individuals rather than having all these individuals go individually to the grocery store in their own vehicles. Such an application also benefits those who are elderly, sick, handicapped, or unable at that time to leave the house.

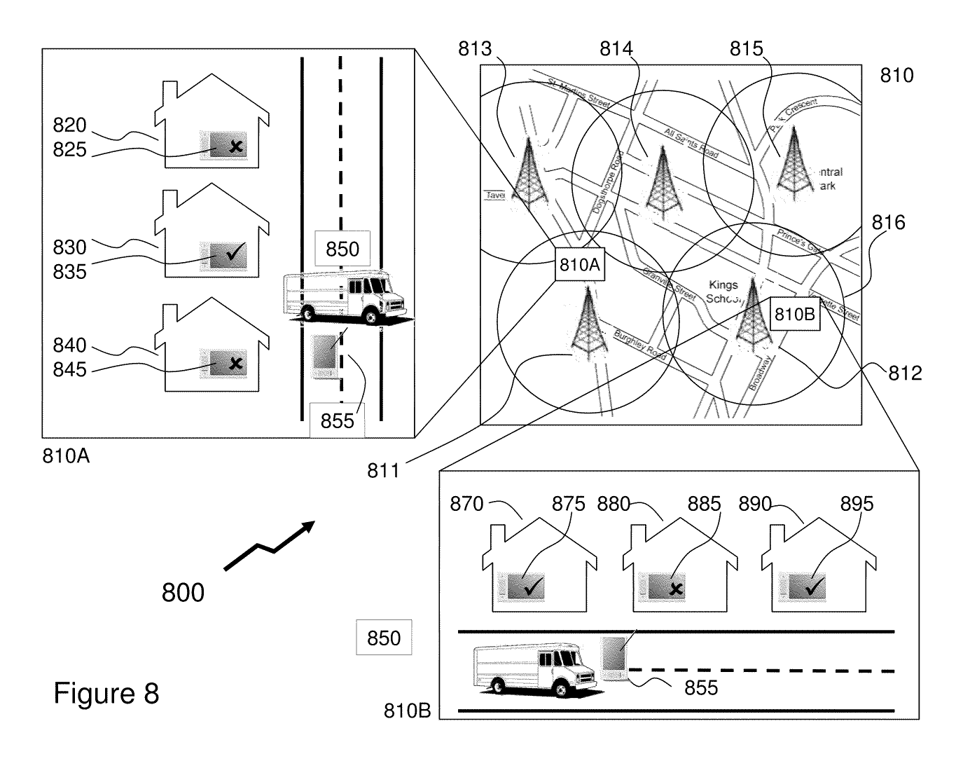

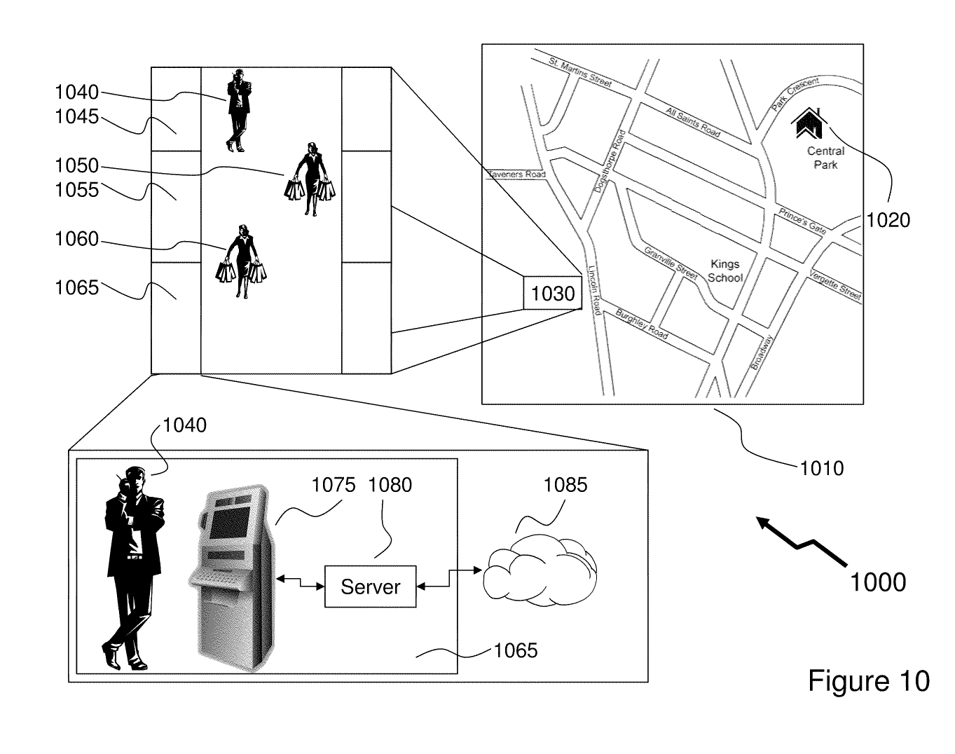

Alternatively the social networking application may be exploited in other aspects such as where communities are encouraging a “free day” which allows people to place items at the end of their driveway anybody is allowed to just pick them up as a way of recycling and using the consumers mentality of trash/treasure such as the “Great Glebe Garage Sale” (www.ottawastart.com/glebe.php). Accordingly the social networking application allows people to advertise, “I'm putting out an Atari system, a record collection and a spare tire that fits a 1987 Ford Taurus” and as people travel within their neighbourhood or another then they receive information as to what's in the “for free” box without having to stop at every house and look. This application may be expanded using other embodiments of the invention such as that in FIGS. 8 and 10 below.

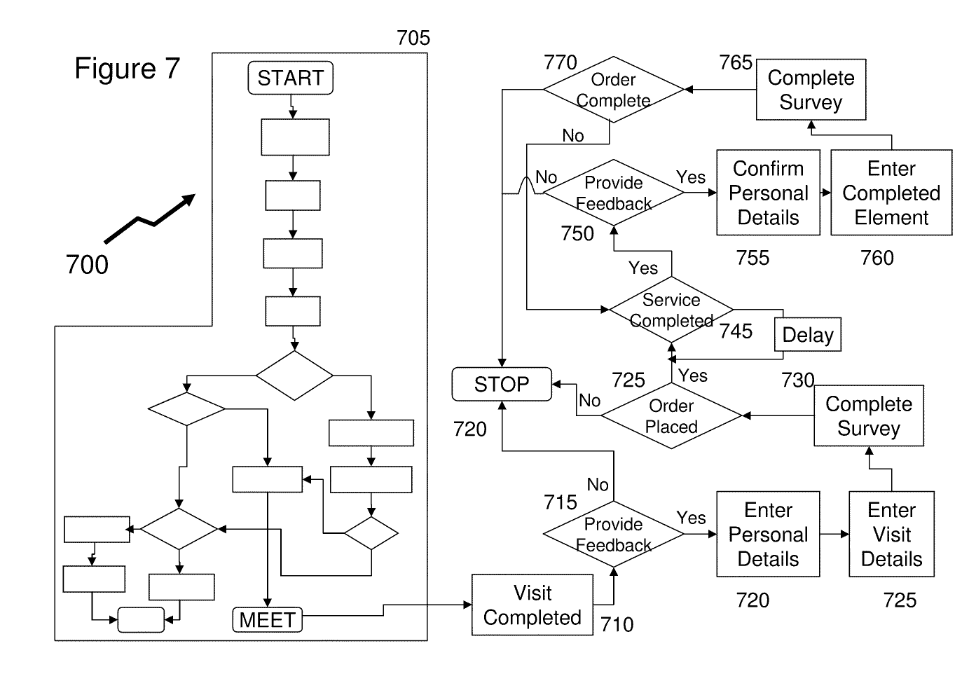

Referring to FIG. 7 there is shown an exemplary process flow 700 of an engagement between a service provider and resident with the resident updating the social networking application. As shown the exemplary process flow 700 begins at first process block 705 which represents the initial engagement between the service provider and the resident, for example such as exemplary process flow 400 of FIG. 4 supra. According to one outcome of the first process block 705 the resident and service provider meet. As such the process moves to step 710 where the meeting and discussions complete, and then to step 715 where the resident is prompted to enter feedback from their meeting. If the decision is made not to enter any feedback the process moves to step 720 and stops.

If the decision is made to provide feedback then the application in steps 720 and 725 prompts the resident for personal details and details concerning the visit respectively. The former allow the application to verify the resident so that the reviews stored are associated with registered users, and the latter to associate the visit and resident to the business. Next in step 730 the resident completes a survey questionnaire and the process moves forward to step 725 wherein the resident is prompted to enter whether an order was placed as a result of the visit either immediately or shortly thereafter. If no order was placed the process moves to step 720 and stops. If an order was placed then the process moves forward to step 745 wherein the resident indicates whether the service was completed as per ordered. If not the process cycles back until the resident indicates whether the service was completed, this loop back including a delay which is predetermined, for example a week. In this manner the resident is reprompted through the social networking application for their feedback in respect of the completion of the order process.

When the resident indicates that the service was completed in step 745 the process moves forward to step 750 and the user is prompted to provide feedback. If the response is no then the process moves to step 720 and stops. Even if the resident does not provide detailed feedback this timing information between placing an order and its completion is information that is beneficial to others who may be considering the service especially if typical completion timelines for example are shown by customers to be say 4 weeks but the salesperson promises 3 days. If the resident determines to provide feedback then the process moves to step 755 wherein they confirm their personal details, then step 760 wherein they indicate the completed portion of the service/product ordered, and then step 765 wherein they complete a questionnaire regarding the completed service/product. Next in step 770 they are asked whether the order they made is complete, if it is then the process moves to step 720 and stops, if not it cycles back to step 745 wherein the resident is prompted as to whether the service has been completed on a delay looped basis.

It would be apparent that rather than structured surveys in respect of the visits, services ordered, services provided etc that the user may be given an open format to simply enter their comments rather than following a predetermined survey. A benefit of the survey is that is provides for some statistical analysis to present subsequent residents with an overview of other peoples views of the business or salesperson without requiring them to work through a large number of entries, i.e. blog style entries.

Optionally the post-meeting aspects of the social networking application may be configured to allow the user to access the application, and select an activity relating to a business they have engaged with. Hence the post-meeting feedback, feedback on service provided etc may be selected from a menu of options, where in some instances the options presented are filtered according to previous activities of the resident within the social networking application.

Referring to FIG. 8 is a schematic 800 of a charity's engagement with residents according to an embodiment of the invention exploiting localized broadcast and ad-hoc networking. As shown within schematic 800 there is a map 810 of a region of Peterborough, England with first and second street regions 810A and 810B respectively. Also shown within the map 810 is a plurality of cellular base stations 811 through 815, i.e. microcells, each with associated coverage 816 for each cellular base station 811 through 815. As shown within first street region 810A a first vehicle 850 equipped with first wireless device 855 is within the coverage 816 of first cellular base station 811. Each cellular base station 811 through 815 has been equipped by the service provider with software supporting the social networking application such that a message transmitted from a master wireless device, i.e. a wireless device pre-designated by the service provider as having this status, and received at a base station is rebroadcast from the base station. In this manner the master wireless device can flood the coverage 816 of the first cellular base station 811 with the request message, and receive back via the first cellular base station 811 all responses from devices within the coverage 816 of the first cellular base station 811, for example first through third nodes 825, 835, and 845 associated with first to third houses 820, 830 and 840 respectively. In this manner a consolidated list of residents with items for collection is provided to the master wireless device, i.e. the first wireless device 855.

Hence, the first vehicle 850 does not need to drive along every street in order to drive along all the streets within first street region 810A to find residents with donations. However, as first vehicle 850 goes to a house, such as second house 830 it establishes an ad-hoc network with second node 835 to either confirm the available donation or to provide a thank you message to the resident advising them that the good were actually collected by the charity rather than being taken by refuse collection or stolen. Next the first vehicle 850 having completed first street region 810A moves forward to second street region 810B wherein it moves into the coverage 816 of second cellular base station 812. The first wireless device 855 now issues another message which is received by second cellular base station 812 and broadcast to all devices within it's coverage 816, for example fourth to sixth nodes 875,885, and 895 of fourth to sixth houses 870 to 890 respectively. In doing so the first wireless device 855 now receives a collated list of donations for the second street region which includes fourth and sixth houses 870 and 890 as indicated by the returned messages from the flooded request message which are transmitted by fourth and sixth nodes 875 and 895 respectively. Again as the first vehicle 850 goes to each of the fourth and sixth houses 870 and 890 the first wireless device 855 establishes ad-hoc networks with the fourth and sixth nodes respectively allowing the communication of a confirmation message from the first wireless device 855 to each of the residents providing donations.

Optionally the flood broadcast message may be an extraction of the “desires” or “wishes” of residents as discussed supra. In this manner the service provider may communicate with all devices associated within a cellular coverage and return from these communications the “desires” and “wishes” of the users within that coverage. This information may be utilized directly by the provider for example if it relates to communications, digital content etc or transferred to partnership businesses if the interests are outside of those of the service provider, i.e. financial services, white goods, etc. Optionally the service provider may extract revenue based upon these referrals to the other businesses either in terms of a single fee per reference or a percentage fee of business identified and executed by the residents.

Alternatively the localized broadcast approach of FIG. 8 may be exploited by service providers to view statistics to see where a potential service offering makes sense. For example is there a neighborhood where many people require a certain type of lawn service, then they will be able to plan where to be at a certain time, such as the evening when most residents are home, or who is more receptive to what they have to offer. Such statistics may for example be collected by the service provider and sold to other commercial enterprises. Further, through the social networking application residents may be able to form a short-term community for a particular service, product and thereby receive a discount as the service provider negotiates with a community rather than individually thereby gaining volume business.

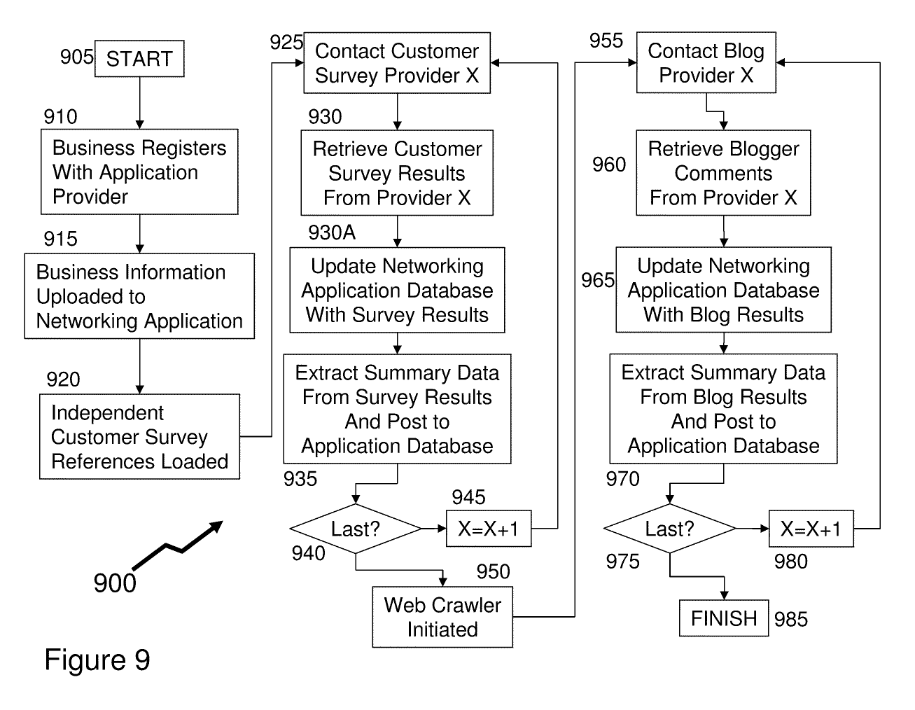

Referring to FIG. 9 there is shown an exemplary process flow 900 for the addition of a new business to the social networking application to retrieve and store customer comments. As described supra for example in FIG. 5 a resident receiving a request from a salesperson may access information relating to the business/products/services etc relating to the salesperson. As such exemplary process flow 900 represents an embodiment of the invention wherein this information is acquired by the social networking application when a new business registers. Accordingly the process begins at step 905 and moves to step 910 wherein a new business registers with the social networking application provider. The process then moves to step 915 with the business information required by the social networking application being uploaded from the business to the social networking application wherein the process moves to step 920 where the business provides information relating to independent customer surveys it has had performed.

The process then moves to step 925 where the first customer survey provider (X=1) is contacted wherein in step 930 the results of this survey are extracted and downloaded into the social networking application database in step 930A wherein summary information is extracted and posted to the social networking application database in step 935. Next at step 940 it is checked whether this is the last survey to be transferred into the social networking application. If another survey exists the counter is updated in step 945, X=X+1, and the process returns to step 925. If the last survey has been loaded then the process moves forward to step 950 wherein a webcrawler application is initiated with a series of keywords generated by the social networking application from the information provided by the business in step 915. Such information including for example the business name, product names, and salesperson names.

In step 955 a first blog application is contacted, such as for example Facebook ™ or Twitter™, in order to retrieve customer posted comments regarding the business (X=1). In step 960 the social networking application retrieves blogger comments from the blog application and in step 965 updates the social networking application database with these comments. Next in step 970 the social networking application extracts a summary of the information retrieved from the blog application and posts this to the social networking application database. Then in step 975 the social networking application determines whether this is the last blog application to be accessed. If not then the counter is updated, X=X+1, in step 980 and the process returns to step 955. If the last blog application has been accessed then the process moves to step 985 and finishes.

It would be evident that in addition to the popular blogging or social networking applications such as Facebook™, Twitter™, etc that the webcrawler may access posted information from a variety of other web based resources including for example financial reports, i.e. Dun and Bradstreet, which address the financial stability of the business, its payment to creditors etc. Additional resources may include but are not limited to personal blogs, websites from resellers, distributor websites, etc.

Referring to FIG. 10 there is a schematic 1000 of a resident notifying a service provider of an interest by forming an ad-hoc network with an item of infrastructure common to their daily routine. As such there is shown a map 1010 of a region of Peterborough, England. A resident, not shown in the map 1010 for clarity, lives at home 1020 on Park Crescent. Within this neighborhood is shopping mall 1030 which they regularly visit for shopping and other services such as banking. Accordingly within shopping mall 1030 are a first to third businesses 1045, 1055, and 1065 which the resident 1040 accesses regularly. Also shown in the shopping mall are other visitors 1050 and 1060 respectively. During a visit to the shopping mall 1030 resident 1040 visits third business 1065 which in this exemplary embodiment is a bank. As such resident 1040 enters the third business 1065 and approaches automatic teller machine (ATM) 1075 in order to perform a financial transaction, for example obtain cash, pay a bill, or deposit a cheque (check). The ATM 1075 is connected to the servers 1080 of the third business 1065 and therefrom to the Internet 1085 (also known as World Wide Web). When resident 1040 comes within range of the ATM 1075 their wireless device (not shown for clarity) forms an ad-hoc network with a wireless transceiver within the ATM 1075 which by virtue of having the social networking application loaded therein can communicate with the resident's wireless device. Accordingly if the resident 1040 has indicated that for example they are seeking to purchase then server 1080 and Internet 1085 allow this information to be transmitted to providers of the goods the resident 1040 seeks or provide the services the resident 1040 seeks.

Optionally the ATM may transmit this extracted information on a time based basis rather than immediately, for example hourly or daily. It would be apparent that the normal item of infrastructure the resident interacts with may be other than an ATM. Other examples including for example traffic lights, pedestrian crossings, fuel dispensers for vehicles, food and beverage dispensing machines, etc. Accordingly an infra-structure may itself be established in an ad-hoc manner that collates and communicates this information to service providers.

Within the embodiments presented supra such as those in FIGS. 3 through 7 for example have assumed that the charity, business, or individual establishing the ad-hoc network with a resident, consumer, or user have a higher end wireless device, such as for example a PDA or cellular telephone. However, the organization employing or exploiting these individual salespeople or canvassers may also optionally exploit a relatively low technology device which is deployed to these salespeople or individuals for example. Whilst limiting the engagement in many scenarios the low technology device would still exploit ad-hoc networking and the principles of the invention disclosed herein. For example this low technology device is simply a card that transmits wireless an identity in one direction, such as might be the case for a charity with thousands nationally for cost reasons, and therefore the detailed text messages etc considered supra may not take place or be possible. There may be some signal externally to the device such as red or green LEDs for example to indicate to the canvasser rejection or acceptance. Alternatively there may be no response or it could be simply somebody pulling the curtain aside, pointing to a sticker on their window indicating that they exploit the social networking application which would mean that the interaction is not going to happen, or an opening of the door to indicate interaction is going to happen. As would be evident to one skilled in the art there are many possible technical solutions which provide the functionality and benefits to the consumer without expensive high-end electronics and lie within the scope of the invention.

Alternatively for the resident, consumer or user the examples presented supra in respect of FIGS. 3 through 7 have assumed that there devices are typically high end wireless devices such as PDAs or cellular telephones. However, their devices or nodes as referred to may be part of another system integrated within their residence such as for example integrated into their “Smart Home” technology management systems, security systems, other home based networks, or be provided as part of a service they receive from a local service provider such as Verizon™, AT&T™, Rogers™, Comcast™ etc. In systems such as security systems the device or node may take the form of an addition to their security keypad as this is typically close to an entrance of a building or be their existing security keypad. In other examples such as home based networks and those provided by local service providers the information could be displayed for example as an insert or overlay to any television, computer, laptop, PDA, cellular telephone or other device current active on the network or accessing services from the service provider.

Whilst not addressed within the exemplary process flows and embodiments supra users of the social networking application may display a sign/sticker that they are part of the system. There is a whole social acceptability aspect that can be addressed by allowing the clients an easy way to say no. Declining action could simply be a person pointing to the sticker and putting their hands up as in “you had the chance to sell me something but because you aren't part of the system, you don't have anything I need or want”, or “you have gotten into the bad books” is an easy way out. In respect of establishing the social networking application as a means of facilitating interactions to the benefit of both sides it is important to show the salesperson or canvasser what the next step is to do business with the residents.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
(a) providing a send device associated with a provider comprising at least a first transmitter operating according to a first wireless standard;
(b) providing a receive device comprising at least a receiver operating according to the first standard and a display, the receive device associated with a user;
(c) receiving at the receive device a request message from the send device, the request message transmitted by other than a public switched telephone network and comprising data relating to at least one of a request for a meeting between the provider and the user and an identity of the provider;
(d) displaying on the receive device a predetermined portion of the request message; and
(e) determining in dependence upon at least the request data an action, the action relating to the request for the meeting between the provider and the user.

2. A method according to claim 1 wherein,
the action comprises at least one of accepting the request at that time, accepting the request with an indication of an alternate time, accepting the request with an indication that a third party will be present, declining the request and doing nothing.

3. A method according to claim 1 further comprising;
(f) transmitting with a second transmitter associated with the receive device a response to the send device, the second transmitter operating according to at least one of the first wireless standard and another wireless standard.

4. A method according to claim 1 wherein step (e) further comprises:
contacting a trusted party in respect of the request and including the outcome of the contact to the third party in the determination of the action.

5. A method according to claim 4 wherein,
the trusted party is at least one of a family member, a friend, a care giver, an individual associated with the residence of the user, an individual associated with the current location of the user; a register of businesses, a register of better businesses, a register maintained by a Government department, and a recognized consumer organization.

6. A method according to claim 1 wherein,
the action is determined in dependence upon a preference, the preference having been selected by the user and stored within the receive device.

7. A method according to claim 1 wherein,
at least one of the send device and receive device are at least one of a wireless telephone, a personal digital assistant, a laptop computer, a personal computer, a telephone connected to a public switched telephone network, a console forming part of a security system, a smart card, an audio-visual device, and a gaming console.

8. A method according to claim 1 wherein,
the first wireless standard comprises at least one of IEEE 802.15.1, IEEE 802.11, IEEE 802.16, ITU-R 5.138, ITU-R 5.150, ITU-R 5.280), RF, GSM 450, GSM 850, GSM 900, GSM 1800, GSM 1900, EDGE, CDMA 2000, UMTS, and AWS 1700.

9. A method according to claim 8 wherein,
when the first wireless standard is one employed by the of send device to communicate with a public switched telephone network the first transmitter operates at an output power such that communication with the public switched telephone network is not possible.

10. A method comprising:
(a) providing a send device of a plurality of send devices, each send device associated with a user comprising at least a first transmitter operating according to a first wireless standard;
(b) providing a receive device comprising at least a receiver operating according to the first standard and a memory, the receive device associated with a provider;
(c) receiving at the receive device a message from the send device of the plurality of send devices, the message transmitted by other than a public switched telephone network and comprising data relating to at least one of a request from the user and an identity relating to the user;
(d) storing within the memory of the receive device a predetermined portion of the message; and
(e) determining in dependence upon at least the data relating to the request a first action.

11. A method according to claim 10 wherein, the first action comprises at least one of contacting the user with information related to the request, contacting the user to establish a meeting, scheduling a delivery related to the request, scheduling a collection related to the request, posting the request as a predetermined portion of Internet accessible audio-visual content, incorporating the request into a predetermined portion of an audio-visual medium, providing acknowledgement that the request has been received and doing nothing.

12. A method according to claim 10 further comprising;
(f) transmitting with a second transmitter associated with at least one of the receive device and another device associated with the provider a response to the send device, the second transmitter operating according to at least one of the first wireless standard and another wireless standard.

13. A method according to claim 12 wherein,
the response comprises at least one of information relating to an identity of an individual associated with an organization capable of fulfilling the request, an identity of an organization capable of fulfilling the request, a price of an item fulfilling the request, a predetermined window of time for a delivery, a predetermined window of time for a collection, a price to purchase an item associated with the request, and an offer to barter in respect of an item associated with the request.

14. A method according to claim 10 wherein,
the action is determined in dependence upon a preference, the preference having been selected by the provider user and stored within the receive device.

15. A method according to claim 10 further comprising:
(f) collating the request from the user with user data obtained from a plurality of other users, the user data relating to other requests of the plurality of other users; and
(g) determining in dependence upon the collated requests data a second action.

16. A method according to claim 15 further comprising:
(h) transmitting with a second transmitter associated with at least one of the receive device and another device associated with the provider a response to the send device, the second transmitter operating according to at least one of the first wireless standard and another wireless standard and the response being generated in dependence upon at least the second action.

17. A method according to claim 10 wherein,
at least one of the send device and receive device are at least one of a wireless telephone, a personal digital assistant, a laptop computer, a personal computer, a telephone connected to a public switched telephone network, a console forming part of a security system, a smart card, an audio-visual device, and a gaming console.

18. A method according to claim 10 wherein,
the receive device comprises a predetermined portion of at least one of an automatic teller machine, a food dispenser, a beverage dispenser, a ticket dispenser, a point of entry to a building, a point of entry to a means of a mass public transport, an element of infrastructure of a means of transport, a means of transport, a point of sale terminal, a cellular base station, a wireless node within a public space and a public telephone.

19. A method according to claim 10 wherein,
the first wireless standard comprises at least one of IEEE 802.15.1, IEEE 802.11, IEEE 802.16, ITU-R 5.138, ITU-R 5.150, ITU-R 5.280), RF, GSM 450, GSM 850, GSM 900, GSM 1800, GSM 1900, EDGE, CDMA 2000, UMTS, and AWS 1700.

20. A method comprising:
(a) providing at least one wireless device of a plurality of wireless devices, each wireless device associated with a user and comprising at least a transmitter operating according to a wireless standard and a memory;
(b) storing within a predetermined portion of the plurality of wireless devices data, the data stored within each wireless device of the predetermined portion of the plurality of wireless devices relating to a request of the user associated with that wireless device of the plurality of wireless devices;
(c) transmitting from a base station operating according to the wireless standard a request; and
(d) transmitting from at least each wireless device of the predetermined portion of the plurality of wireless devices the data relating to the request of the user when the wireless device has received the request.

21. A method according to claim 20 wherein,
the request relates to at least one of an information request, a request to contact an organization, a request to establish a meeting, scheduling a delivery, scheduling a collection, information to be posted as a predetermined portion of Internet accessible audio-visual content, information to form a predetermined portion of an audio-visual medium, a measurement relating to a utility and a request for help.

22. A method according to claim 20 wherein,
each the wireless device of the plurality of wireless devices is at least one of a wireless telephone, a personal digital assistant, a laptop computer, a personal computer, a telephone connected to a public switched telephone network, a console forming part of a security system, a smart card, an audio-visual device, and a gaming console.

23. A method according to claim 20 wherein,
the first wireless standard comprises at least one of IEEE 802.15.1, IEEE 802.11, IEEE 802.16, ITU-R 5.138, ITU-R 5.150, ITU-R 5.280), RF, GSM 450, GSM 850, GSM 900, GSM 1800, GSM 1900, EDGE, CDMA 2000, UMTS, and AWS 1700.
